(19) United States
(12) Patent Application Publication
(10) Pub. No.: US 2011/0144812 A1
(43) Pub. Date: Jun. 16, 2011

(54) WATER MANAGEMENT SYSTEM

(75) Inventors: Stephen Charles Davis, Queensland (AU); Michael Nigel Hunter, Queensland (AU)

(73) Assignee: SENVIRO PTY LTD., Ascot, Queensland (AU)

(21) Appl. No.: 13/058,059

(22) PCT Filed: Aug. 10, 2009
(86) PCT No.: PCT/AU2009/001007

§ 371 Date: Feb. 8, 2011

(30) Foreign Application Priority Data
Aug. 9, 2008 (AU) 2008904076

(51) Int. Cl. A01G 27/00; G05D 9/12

(52) U.S. Cl. 700/281

(57) ABSTRACT

A horticultural system which consists of a container for a plant which sits within a reservoir for irrigation liquid to allow flow of irrigation liquid between the container and reservoir. Irrigation liquid may be to said container and/or said reservoir. Sensor means are located in said reservoir to measure the volume of liquid in said reservoir and a second sensor means in said reservoir measures the electrical conductivity of liquid in said reservoir. A controller is programmed to control the supply of irrigation liquid to the container and/or reservoir using the measurement of liquid height and electrical conductivity in said reservoir. The height sensor consists of a set of electrodes with length equal to the depth to be measured and appropriate electronic circuitry for measuring conductivity between said electrodes and the electrical conductivity sensor consists of a second set of electrodes of short length relative to said first set of electrodes with appropriate electronic circuitry for measuring conductivity between said electrodes.

### BACKGROUND TO THE INVENTION

The need for more effective management of water resources is becoming an ever increasing priority. Automatic watering systems for container horticulture typically operate a fixed time scheduling, with generally no feedback as to whether the potting mix actually needs watering at the time the watering system comes on. Sensors of soil moisture can provide quantitative feedback as to when water is needed, and evapo-transpiration (ET) based irrigation controllers have also been shown to provide significant water savings.

The resupply via capillary action of water in the external reservoir is well known in the art, and there are many examples of systems employing a pot within a pot for this purpose. However this invention relates to the control system for the objective management of drainage and irrigation.

USA patent 4060 discloses a subsurface irrigation system using a reservoir and a float responsive valve.

U.S. Pat. No. 4,819,375 describes an “Aquapot” where a reservoir is located in an annular volume between the walls of two pots. This system requires manual refilling of the reservoir and replacement of an airtight plug. An arrangement of tubes for regulating pressure as the water level drops in the sealed reservoir maintains a water table level at the bottom of the pot containing the plant and water is transferred this pot via capillary action of the potting mix.

U.S. Pat. No. 6,038,813 describes a reservoir between two pots with a raised section in the lower pot to form the reservoir. U.S. Pat. No. 6,038,813 does not employ capillary action to transfer water to the upper pot, nor does it employ any kind of control system to manage water application and drainage.

U.S. Pat. No. 6,237,283 discloses a sub irrigation reservoir system having a control system that utilises moisture sensors in the soil above the reservoirs.

Patent number WO09206587A1 admits water to a preselected level into a reservoir between two pots and controls admission of water to the upper pot containing the plant via a nozzle diaphragm which is opened once the pot becomes dry enough for the pot to float above the diaphragm. Once the upper pot has absorbed enough water its weight increases to the point where the pot presses down on the diaphragm and blocks the water flow.

USA patent application 2007/0094928 (ANOVA®) discloses a plant pot which provides an advanced water management system for potted plants. However without an effective management of water, use of this system may not be commercially viable.

It is an object of this invention to provide improved water management for container horticulture.

### BRIEF DESCRIPTION OF THE INVENTION

To this end the present invention provides a horticultural system which consists of
a) A container for a plant
b) A reservoir for irrigation liquid
c) The reservoir and container being arranged to allow flow of irrigation liquid between the container and reservoir
d) Means for providing irrigation liquid to said container and/or said reservoir
e) Sensor means in said reservoir to measure the volume of liquid in said reservoir
f) Sensor means in said reservoir to measure the electrical conductivity of liquid in said reservoir
g) Control means programmed to control the supply of irrigation liquid to the container and/or reservoir using the measurement of liquid and electrical conductivity in said reservoir.

The invention provides automatic control of watering (and hence drainage) based on the level of water in the reservoir and the electrical conductivity (EC) of the water in the reservoir. The control strategy can be further enhanced through the addition of other sensor inputs such as soil moisture in the plant pot.

The fluid level sensor consists of a set of electrodes with length equal to the depth to be measured and appropriate electronic circuitry for measuring conductivity between said electrodes and the conductivity is measured by a second set of electrodes of short length relative to said first set of electrodes with appropriate electronic circuitry for measuring conductivity between said electrodes.

The zero levels of the two sets of electrodes are aligned or may rest on the same base. The second set of electrodes is used to determine the electrical conductivity of the fluid and calibrate the first set of electrodes with respect to conductivity as a function of length of coverage by the fluid of said first set of electrodes. The relationship between the measured conductivities on said first and second set of electrodes is used to determine when the second set of electrodes is fully covered by the fluid and/or wherein the conductivity signal as a function of time on the second set of electrodes is used to determine when the second set of electrodes is fully covered by the fluid.

This invention provides a very efficient water management system for use with potted plants and hence is particularly suited to the container nursery environment. The system captures drainage water in a reservoir, preferably beneath the pot containing the plant and is re-supplied to the pot preferably through capillary action. The reservoir simply overflows to waste once its capacity has been exceeded.

This invention is able to regulate watering in response to the water level in the reservoir and the conductivity of the water in the reservoir. Water may be added directly to the reservoir or applied to the plant pot. It may be advantageous to apply water to the plant pot to prevent the upper layers of the plant pot drying out too much and to prevent salt accumulation on the surface. The level and rate of change of the level in the reservoir may be used to ascertain when to switch the watering on and off. For example the system is preferably programmed to learn how much water is added to the reservoir as a function of time the watering is activated, and use this to add the required amount to the reservoir without any overfilling and run off. When applying water to the plant pot this takes into account percolation rate through the media in the plant pot. A system based on a float switch would only switch off the watering system when the level in the reservoir reached the set switch level, and not account for that water that may still be percolating through the plant pot which could result in overflow and runoff.

This invention is able to provide a level sensing system based on measurement of conductivity which can provide measurement down to a zero level when there is no water at all in the system.

### DETAILED DESCRIPTION OF THE INVENTION

Preferred embodiments of the invention will be provided with reference to the drawings in which

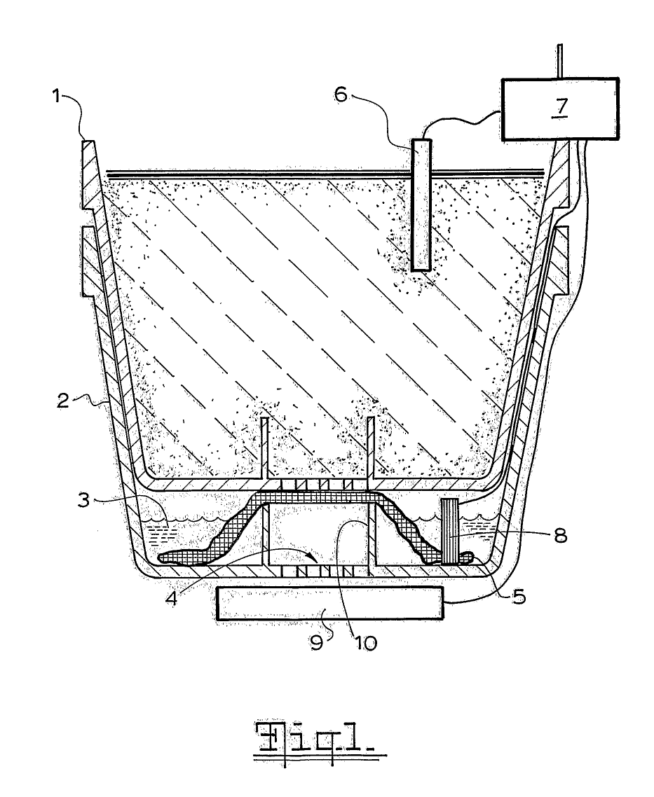

FIG. 1 shows an embodiment of the invention including a soil moisture sensor and a gravimetric sensor;

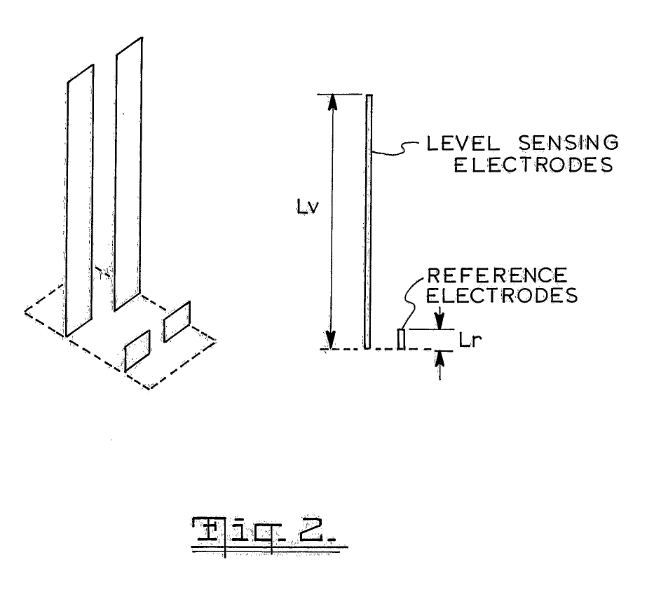

FIG. 2 shows a schematic of the level/EC sensor;

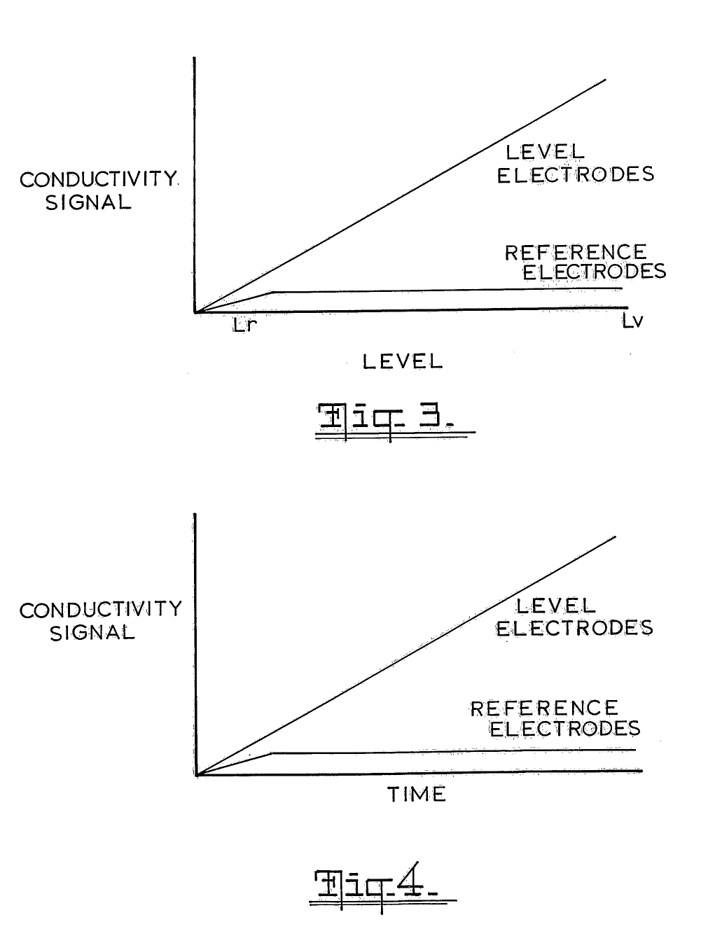

FIG. 3 shows the conductivity signal on the level sensor electrodes as a function of the water level in the reservoir;

FIG. 4 shows the conductivity signal on the level sensor electrodes as a function of time as the level rises in the reservoir during a filling cycle.

FIG. 1 shows a preferred embodiment of the invention. In this embodiment two ANOVApot® (WO05058016A1 or USA patent application 2007/0094928) 1,2 are used. The pot has a collar 10 in the bottom allowing the storage of water. Drainage water from the upper pot 1 flows through its basal grid and is diverted by the capillary tape 5 (impervious on the lower side) to accumulate around the central well in the lower pot 2. Once the water level rises above the height of the collar, it flows out through the grid holes 4 in the centre of the collar. The upper pot 1 contains the plant (plant pot) and the lower pot 2 forms a reservoir. The upper pot fits snugly into the lower pot to minimise evaporation and reduce access for mosquitoes. The grid holes of the upper pot are in contact with a geotextile tape 5 which draws water up from the reservoir by capillary action. Any water in excess of the reservoir capacity will flow out of the grid holes in the lower pot.

An EC/water level sensor 8 is situated in the reservoir 3 in the lower pot and is connected to a radio head unit 7 (shown in FIG. 1 attached to the side of the pot) which relays the data to a receiver/logger unit. The receiver/logger unit can be interfaced to an irrigation controller. Other sensors such as a soil moisture sensor 6 relative humidity sensor, air flow sensor and gravimetric sensor 9 may also be connected to the radio head.

The rate of fall in the reservoir level (and hence volume) will be related to evapo-transpiration. The level in the reservoir will affect the rate at which the water can be transferred from the reservoir to the plant pot through capillary action. The maximum rate occurs when the reservoir is full since the height through which water is drawn up is minimised. It will be possible to regulate the degree of wetness of the media in the plant pot through a combination of the level set in the reservoir and composition of the media (for example increasing the amount of coir in the media will increase the water holding capacity and the ability to draw water upwards into the plant pot). It may also be advantageous to schedule some periods of water stressing of the plant to promote a specific plant response such as flowering or reduced shoot growth, in which case the length of time which the reservoir is empty can be controlled. The control system can be made more sophisticated by adding inputs from other sensors such as a soil moisture sensor. In this case the soil moisture sensor provides a quantitative measure of the wetness of the media in the plant pot and can provide feedback as to what level to maintain in the reservoir. If potting media dries out too far it may become hydrophobic and difficult to re-wet. In this hydrophobic state the ability of the media to draw water upwards into the pot is also significantly diminished. The use of a soil moisture sensor in the upper pot is one way of characterising the minimum level to which the pot is allowed to dry out before reaching this hydrophobic condition.

Nutrient deficiencies or excess salinity will be indicated by the EC level of the water in the reservoir. With no run off from the reservoir the EC may tend to increase over time. As the EC level becomes excessive a flush cycle can be triggered which will add a greater volume than the reservoir to dilute the reservoir contents. A flush cycle could also be initiated to remove stagnant water that may develop in the reservoir during periods of low evaporation.

If a gravimetric sensor is used to weigh the whole two pot arrangement a quantitative measure of evapo-transpiration can be obtained. If the water is added to the plant pot such that the reservoir does not overflow, the reduction in weight of the system over time provides a measure of the total water loss from the system. The proportion of this loss re-supplied from the reservoir can be calculated from the change in level, and hence volume, of the reservoir. The balance is water lost from the plant pot which equates to evapo-transpiration. The use of a system such as this makes it possible to determine relative water use efficiencies for the plants.

In a preferred embodiment of the invention the level (height) sensor is based on measurement of the EC of the solution, thereby combining the two required measurements within the same device. A similar idea for level sensing of water in a washing machine tub has been proposed in U.S. Pat. No. 6,810,732. The principle utilises the fact that the conductivity measured between a set of vertically aligned electrodes will be dependent on the area of the electrodes covered by the water, and hence on the level of the water. The absolute conductivity signal measured on the vertical electrodes will however also be dependent on the EC of the water solution, and hence it is necessary to have a reference measurement of the EC of the water in order to be able to calibrate the scale on the vertical electrodes. U.S. Pat. No. 6,810,732 uses a smaller set of electrodes located below the vertical level electrodes in a region where they will remain covered by the water to provide a reference measurement. However in this invention there may not necessarily be another region of water present in which to situate the reference electrodes, and since it is required to be able to measure down to a zero level of the reservoir then by definition any reference electrodes will not always be totally covered by water. It is an aspect of this invention to provide a level sensing system based on measurement of conductivity which can provide measurement down to a zero level when there is no water at all in the system, i.e. the reference electrodes do not have access to a separate water volume as in U.S. Pat. No. 6,810,732. In a preferred embodiment some short reference electrodes of length Lr are situated in line with the base of the long level sensing electrodes of length Lv so the bottom of the reference electrodes and the bottom of the level sensing electrodes (i.e. their zero levels) are aligned as shown in FIG. 2, and the measured signal on the reference electrodes is also used to determine levels in the zero to Lr range. It is also an aspect of the invention to use an AC or switched voltage in measuring the conductivities of this configuration, as opposed to the DC voltages specified in U.S. Pat. No. 6,810,732.

The measured conductivity signal on the reference electrodes will also depend on the level of coverage of the reference electrodes as there will be a relationship between the level of coverage of the electrodes and the measured conductivity. FIG. 3 shows a proportional relationship between the measured conductivity and the water level on the electrodes. The conductivity signal on the reference electrodes will increase until the electrodes are completely covered and stay substantially constant as the water level increases further. In the case of a proportional relationship as shown in FIG. 3, for non-zero levels the ratio of the signal on the level electrodes to the signal on the reference electrodes will be a constant value up until the point where the reference electrodes becomes fully covered. Beyond this level the ratio will continue to increase until it reaches a maximum value when the level electrodes are fully covered. When there is no water both the reference and level electrodes will read zero. If the relationship between conductivity and level covered is non-linear it will be possible to characterise the relationship and derive the form of the ratio between the two signals. The ratio of measured signals can thus be used to determine when the reference electrodes are fully covered. Whenever the reference electrodes are fully covered, the EC of the reservoir water is known and the value can be used to calibrate the level electrodes. It will also be possible to know when the reference electrodes are covered from the time profiles as the reservoir fills from low levels during a watering event. In this case the same behaviour will be observed as a function of time as shown in FIG. 4, i.e. the conductivity signal will continue to increase as the level increases and the reference electrodes will be fully covered much earlier.

In the application envisaged it is unlikely that the EC level will change significantly once the level drops below Lr since this is likely to be a drying cycle where the plant is not watered for a period of time. When the plant is watered, sufficient water will usually be added to cause coverage of the reference electrodes as these will be very short relative to the level electrodes. In this case the levels between zero and Lr can be measured using the EC value when the reference electrodes were last fully covered. Conductivity signals less than this maximum reference value will indicate that the last maximum reference signal should be used in calibrating the level electrodes. Thus the signal maxima on the reference electrodes should be regularly stored and updated as a function of time. If the level remained between zero and Lref for a long period of time, a watering cycle could be triggered to provide sufficient water to cover the reference electrodes and hence allow re-calibration of the EC.

1. A horticultural system which consists of
a) A container for a plant;
b) A reservoir for irrigation liquid;
c) The reservoir and container being arranged to aloes flow of irrigation liquid between the container and reservoir;
d) Means for providing irrigation liquid to said container and/or said reservoir;
e) Sensor means in said reservoir to measure the liquid in said reservoir;
f) Sensor means in said reservoir to measure the electrical conductivity of liquid in said reservoir;
g) Control means programmed to control the supply of irrigation liquid to the container and/or reservoir using the measurement of liquid and electrical conductivity in said reservoir.

2. A horticultural system as claimed in claim 1 wherein the volume of water in the reservoir is determined using the measurement of electrical conductivity of the water in the reservoir.

3. A horticultural system as claimed in claim 1 wherein the volume sensor consists of a set of electrodes with length equal to the depth to be measured and appropriate electronic circuitry for measuring conductivity between said electrodes and the electrical conductivity sensor consists of a second set of electrodes of short length relative to said first set of electrodes with appropriate electronic circuitry for measuring conductivity between said electrodes.

4. A horticultural system as claimed in claim 3 wherein the zero levels of the two sets of electrodes are aligned.

5. A horticultural system as claimed in claim 3 wherein said second set of electrodes is used to determine the electrical conductivity of the fluid and calibrate the first set of electrodes with respect to conductivity as a function of length of coverage by the fluid of said first set of electrodes.

6. A horticultural system as claimed in any preceding claim where the measurement of medium moisture level or medium moisture tension in the vessel is also utilized in the watering control strategy.

7. A horticultural system as claimed in claim 1 wherein a gravimetric sensor is used to determined weight and/or change in weight of the vessel and reservoir and utilized in the watering control strategy.

8. A horticultural system as claimed in claim 1 wherein input from other environmental sensors including relative humidity, temperature, air flow and/or solar radiation are utilized in the watering control strategy.

9. A horticultural system as claimed in claim 1 wherein input from other sensors on the plant include leaf wetness, stem diameter and/or leaf chlorophyll content are utilized in the watering control strategy.

10. A control system for use in the horticultural system of claim which includes
a) Sensor means adapted for insertion in said reservoir to measure the volume of liquid in said reservoir;
b) Sensor means adapted for insertion in said reservoir to measure the electrical conductivity of liquid in said reservoir;
c) Control means programmed to control the supply of irrigation liquid to the container and/or reservoir using the measurement of liquid volume and electrical conductivity in said reservoir;
wherein the volume sensor consists of a set of electrodes with length equal to the depth to be measured and appropriate electronic circuitry for measuring conductivity between said electrodes and the electrical conductivity sensor consists of a second set of electrodes of short length relative to said first set of electrodes with appropriate electronic circuitry for measuring conductivity between said electrodes.

11. A control system as claimed in claim 10 wherein said second set of electrodes is used to determine the electrical conductivity of the fluid and calibrate the first set of electrodes with respect to conductivity as a function of length of coverage by the fluid of said first set of electrodes.
